(19) United States
(12) Patent Application Publication
(10) Pub. No.: US 2013/0110570 A1
(43) Pub. Date: May 2, 2013

(54) SCHEDULING AND BILLING PROGRAM FOR EXACT TIME AND CALLBACK TWO-WAY VIDEO APPOINTMENTS, AND PROGRAM TO ADD TWO-WAY VIDEO AND SCHEDULING AND BILLING TO EXISTING WEBSITES IN A SIMPLE MANNER

(71) Applicant: Me2Doc LLC, New York, NY (US)

(72) Inventor: Joseph AMENT, New York, NY (US)

(73) Assignee: ME2DOC LLC, New York, NY (US)

(21) Appl. No.: 13/665,258

(22) Filed: Oct. 31, 2012

Related U.S. Application Data
(60) Provisional application No. 61/554,194, filed on Nov. 1, 2011.

(51) Int. Cl. G06Q 10/10

(52) U.S. Cl. 705/7.19

(57) ABSTRACT

The present disclosure provides a program for scheduling video and/or e-mail appointments. The program is web-based or downloadable, and allows a doctor or other professional to schedule a series of short, sequential appointments online with a patient. A billing module in the program can collect payment from the patient. The program thus allows professionals to conveniently schedule appointments and receive compensation for time that may otherwise have been lost. The disclosure also provides a program to add two way video as well as scheduling and billing functionalities to an existing website in a simple and integrated manner.

### CROSS-REFERENCE TO RELATED APPLICATIONS

The present application claims priority to U.S. Provisional Patent Application No. 61/554,194, filed on Nov. 1, 2011, the disclosure of which is herein incorporated by reference.

### BACKGROUND OF THE DISCLOSURE

1. Field of the Disclosure

The present disclosure relates to a video and/or electronic mail (e-mail) billing and scheduling program. More particularly, the present disclosure relates to a scheduling program that allows multiple users (such as professionals and businesses) to effectively queue a block of consecutive and/or callback video or email appointments with different clients and allow professionals (or businesses) to get paid for their consult time.

The present disclosure also relates to a program that can be added to any Web site, in a simple manner, to provide the following three features: two-way video feed, scheduling for the video feed, and billing for the video feed.

2. Description of the Related Art

In any field that requires that requires a trained professional to visit with a patient, client, or customer to diagnose or discuss an issue, it is always a goal to save time, money, and convenience for both the professional and the client. Often times, a busy professional does not have sufficient time in his schedule to accommodate his clients' need for face to face brief meetings and consultations. Also, it is difficult for the professional to schedule consecutive in-person consultations with a number of different clients in a set time frame (e.g., five clients in thirty minutes). In-person meetings are often set for fifteen to thirty minutes or more, when a brief five to ten minute meeting might suffice, or allow determination that a second meeting is required.

Ordinarily, the professional will not schedule multiple consecutive in-person five to ten minute meetings with multiple different outside clients, as he is respectful that the clients travel and waiting time could be much longer than the meeting itself.

Accordingly, there is a need to address these concerns.

### SUMMARY OF THE DISCLOSURE

In one embodiment, the present disclosure provides a method of connecting a first user and a second user via a video and/or e-mail appointment. The method comprises the steps of: storing profile information relating to the first user and the second user, displaying a schedule to the first user and the second user through first and second interfaces, respectively, wherein the first user selects times that they are available for the video appointment, and the second user selects one of the times to schedule the video appointment; prompting the first and second user automatically to initiate the video appointment at the time selected by the second user; and terminating the video appointment at the end of the time selected by the second user. Upon completion of the appointment, the billing module automatically collects payment from the first users previously entered credit card information.

In another embodiment, for a callback appointment, the present disclosure provides a method of connecting a first user and a second user for an appointment. The method comprises the steps of storing profile information relating to the first user and the second user, displaying a first version of a schedule to the first user through a first interface and a second version of the schedule to the second user through a second interface, wherein the first user selects periods of times from the first version of the schedule when they are available for a callback appointment, wherein the periods of times are displayed in the second version of the schedule to the second user, and the second user selects one of the periods of times to schedule the appointment, and initiating the appointment, upon a signal from the first user, at a set time within the period of time selected by the second user.

In another embodiment, the present disclosure provides a program resident on a processor. The program comprises a profile module for storing information relating to a first user and a second user, a scheduling module, wherein the scheduling module displays a first version of a calendar to the first user and a second version of the calendar to the second user, wherein the first user selects specific time slots on the first version of the calendar for displaying to the second user, and the second user selects one of the time slots for scheduling an appointment with the first user, and a billing module for collecting payment from the second user for the appointment. The scheduling module automatically reminds the first and second users to initiate the appointment at the beginning of the time slot selected by the second user.

In another embodiment, the program is accessible through a user interface element on at least one of the first interface and the second interface. The user interface element enables the first user to add or integrate two-way video, scheduling, and billing, to an existing Web site. The second user accesses a second version of the user interface element through the second interface.

### BRIEF DESCRIPTION OF THE DRAWINGS

FIG. 1 shows a schematic diagram of a first embodiment of the program of the present disclosure;

FIG. 2 shows a schematic drawing of a scheduling module screen that can be shown through a first interface of the program of the present disclosure; and

FIG. 3 shows a schematic diagram of a second embodiment of the program of the present disclosure

### DETAILED DESCRIPTION OF THE DISCLOSURE

The present disclosure provides a program that can be used by a first user and a second user, each at separate locations. The program of the present disclosure can be used to connect a medical practitioner and a patient, or parties in any number of relationships, such as, but not limited to, lawyer/client, therapist or psychiatrist/patient, tutor and pupil, utility professional (such as a plumber, auto mechanic, or electrician) and a customer, or any interactions between a first user and a second user that may apply. The program of the present disclosure is preferably used for users that have some sort of pre-existing relationship, as described in more detail below. For ease of description only, the program of the present disclosure is discussed below in the context of a doctor and a patient, and in the claims as a first user and a second user, respectively.

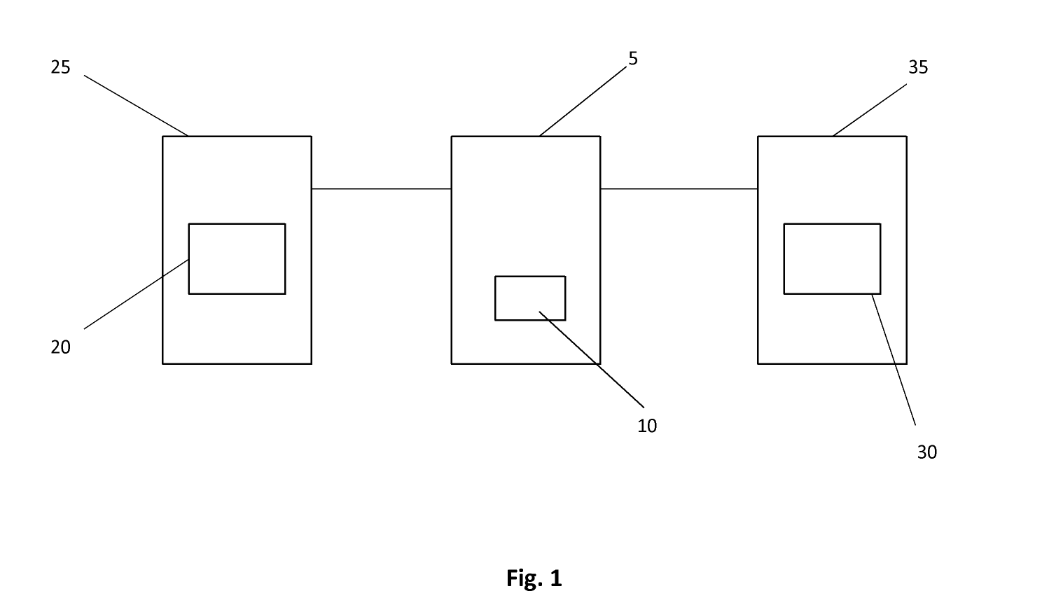

FIG. 1 shows a schematic diagram illustrating how program 10 of the present disclosure is used. Program 10 of the present disclosure has a first interface 20 that is accessed by the doctor at a first station 25, and a second interface 30 that is accessed by the patient at a second station 35. Program 10 can reside on server 5, which is accessed by the doctor and the patient. The patient and the doctor can either use program 10 through a browser-based Web site, or program 10 can be in the form of a software package that each user or both users download to their respective stations.

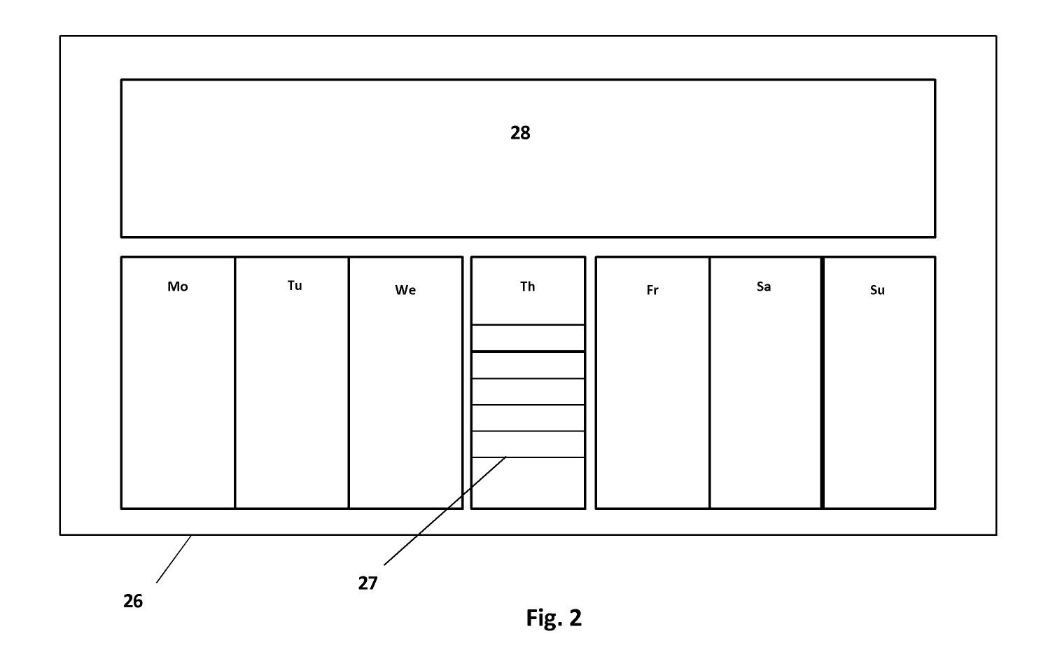

Program 10 has a scheduling module that displays a schedule to the doctor through first interface 20 (an example is shown in FIG. 2). The doctor can set specific time slots in the schedule when he is available for video or e-mail conferencing with one or more patients. The scheduling module also displays a different version of the schedule to the patient through second interface 30, and the patient can select available time slots for appointments. The patient cannot change the available times of the doctor. Again, in one embodiment, the doctor and the patient have a pre-existing relationship, meaning that only the doctor's regular and pre-existing patients have access to the doctor's schedule through program 10. The doctor can set the length of time for the video or e-mail appointments, and set a rate to charge the patient (if desired) for the appointment, discussed in greater detail below.

If the patient and doctor schedule a video appointment, they will be able to see each other through viewing devices (e.g. a camera) at their respective interfaces. If they schedule an e-mail appointment, there will be no video, but they will be connected through messaging or e-mail windows, again at each user's respective interface. Program 10 also contemplates that the appointment can include both video and e-mail communication between the doctor and patient. The doctor and patient may also communicate at the scheduled time through chat, text (e.g., SMS), instant, or other messaging methods.

The scheduling module can send reminders to both the doctor and patient before the scheduled appointment, such as via e-mail, or messaging and/or an automated call to a mobile communications device or land-based telephone line. The scheduling module can also allow the doctor to initiate a reminder. The scheduling module can queue waiting patients, and remind the doctor of the start time for each consecutive appointment, such that the patient's appointment begins and ends exactly when it is supposed to. It can list upcoming appointments in first interface 20, visible to the doctor, so he is aware of the upcoming schedule. Optionally, the scheduling module can display a countdown timer to maintain on time performance. The scheduling module can also automatically disconnect a current visit at the completion of the scheduled time. The scheduling module can also prompt each user through each interface to begin the scheduled appointment by clicking a user interface element (e.g., button) on the screen. In one embodiment, the scheduling module sets the length of appointments at from five to forty-five minutes, or any subranges in between, and the doctor can choose rates to charge from $15 to $200 per appointment, or any subranges in between. The doctor can change these parameters as needed.

As an alternative to exact time slots for appointments, the scheduling module of program 10 can allow the doctor to post a period of time (such as Wednesday from 1 pm to 4 pm) during which the doctor is available to initiate a video or email appointment. The patient then selects the period of time during which he wishes to be contacted by the doctor. This allows the doctor to have more flexibility in his schedule. Instead of having to adhere to an exact time for a video or email appointment, the doctor can set a time range during which he can initiate the appointment at his convenience. The scheduling module can set the periods of time of availability for the doctor to be from half an hour to four hours. The doctor may also limit the number of patients who are allowed to book during the posted callback time period.

Program 10 can also include a billing module integrated therein that can collect payment from the patient, such as from a credit card. The billing module can send a request to the patient through second interface 30, to collect the patient's payment information. The billing module can also send a message to the doctor through first interface 20 to notify the doctor that payment has been received. The billing module ensures that the patient is only charged when the scheduled appointment has occurred, and then automatically deposits the collected fee to the doctor's account (deducting a processing fee if applicable). The billing module also sends a confirmation email to the doctor and patient regarding the payment.

Program 10 can also have a profile module that stores relevant biographical information for the doctor and patient, and prompts each party through their respective interface for the same. The profile module can also store user names and passwords for each user. Program 10 stores the relevant information for a number of doctors, and the patient can search program 10 to see if the desired doctor is available through program 10.

Thus, program 10 provides several advantages not available in current systems. It provides a way for clients/patients/customers to make online video or e-mail appointments with their physicians or other professionals through an online appointment book visible to both parties, at an exact time in the future. It is advantageous to the patient in that he knows the exact time when the doctor can be reached or is available for a callback, and does not have to travel to the doctor's office to meet. The patient knows exactly when the doctor is available, can book an online appointment, and then be connected to the doctor for a video consultation at an exact appointment time. During the video appointment, the doctor and patient can decide if a second appointment is necessary, saving both parties valuable time. Program 10 also allows the doctor to schedule a block of consecutive brief video or e-mail appointments with his clients to efficiently use his time. Program 10 also allows the doctor to keep track of the time spent on each video consultation so he can be properly compensated for his time. This is revenue that otherwise may be lost by not being collected at all. In addition, program 10 allows the doctor to set the exact length of each visit, allowing him to book successive online visits in an efficient manner. The program automatically sends both users reminders about the upcoming visit at scheduled intervals.

Program 10 can interface directly to online video or social media sites such as (but not limited to) Skype™ or Webex™. If either the doctor or patient has an account on any of these sites, the scheduling module of program 10 can access each user's account with those sites, once they are granted permission. If either party does not have the software for any of these sites, they can download the applicable software (e.g., Webex) at the time of making an appointment from a button or link on first interface 20 or second interface 30.

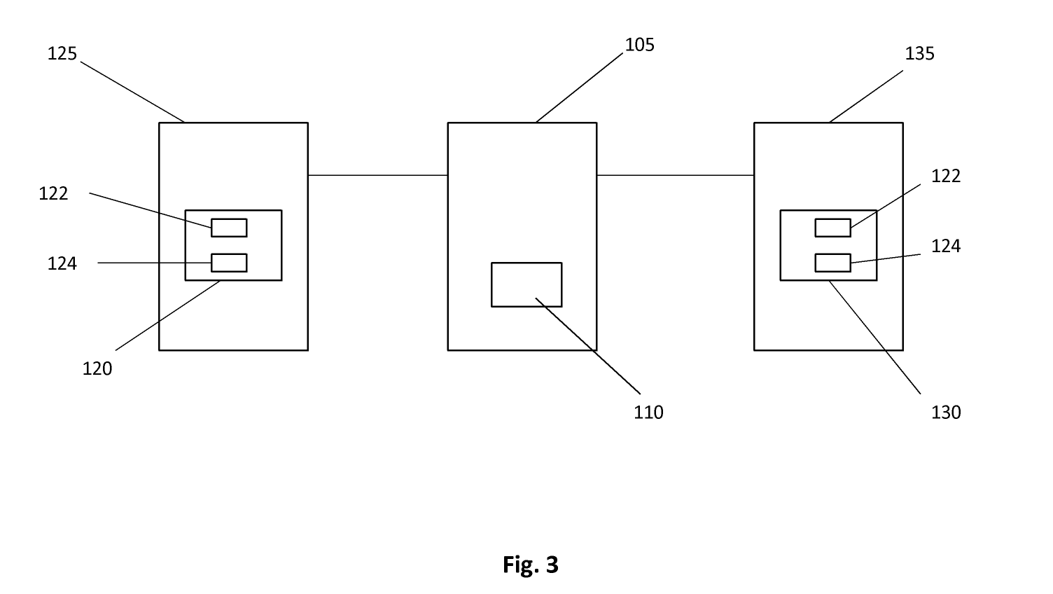

In another embodiment, shown in FIG. 3, the program of the present disclosure can add integrated two way video appointments and video scheduling and billing to any existing website or social media page (e.g. Facebook) in a simple manner and with a single downloadable program. In this embodiment, program 110 allows any business or party operating a Web site to add the features discussed above, which can be accessed with a single click to user interface elements (e.g., button) on an existing page. The program not only provides scheduling and billing, but actually adds two way video feed to any existing website. This greatly expands the utility and functionality of many types of websites and saves significant time and effort for the website owner. Current methods for scheduling and billing and adding two way video appointments to an existing website involve multiple time consuming steps (such as custom designing integrated scheduling and billing programs and custom embedding two way video into an existing website). Current methods for adding the above functionalities are not automated, not integrated and not embeddable into any web site.

In this embodiment, the doctor access program 110 through a first interface 120 at a first station 125, and the patient accesses program 110 through a second interface 130 at a second station 135. Program 110 resides on server 105. A first user interface element 122 on each of interfaces 120 and 130 can be titled “Schedule Video Appointment” or something suitably similar, and a second user interface element 124 can be titled “Start Video Appointment” or something suitably similar. Again, describing this embodiment in the context of a doctor and patient, when first user interface element 122 is clicked by the doctor (or the website business owner), the doctor is brought to the first version of the scheduling module described above in program 10. In the manner described above, the doctor posts the times he is available, and also posts his fees for online two-way video appointments. When first user interface element 122 is clicked by the patient, the patient is brought to the doctor's appointment calendar, and is able to view the available times for a two-way video appointment, as discussed above with respect to program 10. The patient selects an available appointment, and then pays the first party's fee for that appointment with a credit card. The patient is only charged for the appointment after it is complete.

Second user interface element 124 (“Start Video Appointment”) is clicked by both the first and second party a few minutes before the appointment, and both parties are brought from the Web site to a video portal page to conduct the video appointment.

As with the first embodiment described above, in this embodiment program 110 can automatically notify both the doctor and patient by SMS message, and/or e-mail, and/or automated phone call a few minutes before the appointment to remind them of the appointment starting time. In addition to two way video, both parties can share their desktops and documents. Thus, in this embodiment, program 110 enables any web site to schedule, charge for, and conduct paid, secure and encrypted two-way video appointments with a single click and in an integrated fashion.

The term “module” is used for ease of description in the present disclosure, and is not meant to be limiting. Programs 10 and 110 can be written in such a way that they utilize modules as separate parts of the code, but do not require their use. Programs 10 and 110 may be implemented on any computing or communication devices with video or messaging capabilities, such as desktop computers, laptops, or mobile devices. The doctor and patient may be on different types of devices. For example, the doctor may be on a desktop computer while the patient uses a mobile device.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A method of connecting a first user and a second user for an appointment, comprising the steps of:
storing profile information relating to the first user and the second user;
displaying a first version of a schedule to the first user through a first interface and a second version of said schedule to the second user through a second interface, wherein the first user selects times from said first version of said schedule that they are available for the appointment, said times being displayed in said second version of said schedule to the second user, and the second user selects one of said times to schedule the appointment;
prompting the first and second user automatically to initiate the video appointment at said time selected by the second user, wherein the appointment is at least one of a video and an electronic mail appointment; and
terminating the appointment at the end of said time selected by the second user.

2. The method of claim 1, further comprising the step of collecting a payment from said second user.

3. The method of claim 1, wherein profile information relating to multiple first users and multiple second users is stored, and the method further comprises the step of, before said displaying step, matching one of said first users to one of said second users.

4. The method of claim 1, wherein said first user is a doctor, and said second user is a patient.

5. The method of claim 1, wherein the appointment is a video appointment.

6. The method of claim 1, wherein the appointment is an e-mail appointment.

7. The method of claim 1, further comprising the step of sending a reminder to at least one of said first user and said second user before said initiating step.

8. A method of connecting a first user and a second user for a callback appointment, comprising the steps of:
storing profile information relating to the first user and the second user;
displaying a first version of a schedule to the first user through a first interface and a second version of said schedule to the second user through a second interface, wherein the first user selects periods of times from said first version of said schedule when they are available for a callback appointment, wherein said periods of times are displayed in said second version of said schedule to the second user, and the second user selects one of said periods of times to schedule the appointment;
prompting the first user automatically to initiate the video appointment at said time selected by the second user, wherein the appointment is at least one of a video and an electronic mail appointment.

9. The method of claim 8, further comprising the step of collecting a payment from said second user.

10. The method of claim 8, further comprising the step of sending a reminder to at least one of said first user and said second user before said initiating step.

11. A program resident on a processor, the program comprising:
a profile module for storing information relating to a first user and a second user;
a scheduling module, wherein said scheduling module displays a first version of a calendar to said first user and a second version of said calendar to said second user, wherein said first user selects specific time slots on said first version of said calendar for displaying to said second user, and said second user selects one of said time slots for scheduling an appointment with said first user; and
a billing module for collecting payment from said second user for said appointment,
wherein said scheduling module initiates the appointment the beginning of said time slot selected by said second user, upon receiving a signal from said first user and said second user.

12. The program of claim 11, wherein said first user views said first version of said calendar though a first interface, and said second user views said second version of said calendar through a second interface that is remote from said first interface.

13. The program of claim 11, wherein said appointment is a video appointment.

14. The program of claim 11, wherein said scheduling module sends a reminder message to at least one of said first user and said second user before said appointment.

15. A program resident on a processor and for the addition of two-way video to a Web site, the program comprising:
a profile module for storing information relating to a first user and a second user;
a scheduling module, wherein said scheduling module displays a first version of a calendar to said first user in a first interface and a second version of said calendar to said second user in a second interface that is remote from said first interface, wherein said first user selects specific time slots on said first version of said calendar for displaying to said second user through said second interface, and said second user selects one of said time slots for scheduling an appointment with said first user; and
a billing module for collecting payment from said second user for said appointment,
wherein the program displays at least one user interface element in each of said first interface and said second interface, and
wherein said scheduling module initiates said appointment the beginning of said time slot selected by said second user, upon receiving a signal from said first user and said second user.
